(19) United States
(12) Patent Application Publication
(10) Pub. No.: US 2019/0105800 A1
(43) Pub. Date: Apr. 11, 2019

(54) METHOD AND APPARATUS FOR FORMING MARBELIZED ENGINEERED STONE

(71) Applicant: Alex Xie, West Windsor, NJ (US)

(72) Inventor: Alex Xie, West Windsor, NJ (US)

(21) Appl. No.: 15/726,877

(22) Filed: Oct. 6, 2017

(51) Int. Cl. B28B 1/00; B44F 9/04; B28D 1/24; B01F 7/20; G05B 19/402

(52) U.S. Cl. CPC B28B 1/005; B44F 9/04; B28D 1/24; E04F 13/144; G05B 19/402; G05B 2219/39102; B01F 7/20

(57) ABSTRACT

An apparatus including a computer processor; a first tool device; a first device configured to hold the first tool device; and a second device configured to move the first tool device in x, y, and z directions, when the first tool device is being held by the first device, in response to commands from the computer processor; and a conveyor device having a belt. The first tool device may include a wheel. The first device may be configured with respect to the conveyor device, so that the wheel of the first tool device is configured to be lowered in the z direction into a material located on the belt of the conveyor device, and the first tool device is configured to be moved in the x and y direction, with the wheel simultaneously rotating and rolling through the material on the belt, in response to commands from the computer processor.

### FIELD OF THE INVENTION

This invention relates to methods and apparatus for forming engineered stone.

### BACKGROUND OF THE INVENTION

Quartz is the second most abundant mineral in the Earth's crust and one of the hardest naturally occurring materials. One of its many uses is in “engineered stone”. Engineered stone, including quartz, has become a common surfacing and countertop choice in many countries throughout the world. Its applications include kitchen and bathroom countertops, tables and desktops, floor tile, food service areas, wall cladding, and various other horizontal and vertical applications.

The production of engineered stone generally involves particulate materials such as ground quartz rock, crushed glass, rocks, pebbles, sand, shells, silicon, and other inorganic materials combined with polymers, binders, resins, colorants, dyes, etc. The particulate material(s) may be varying sizes ranging from four hundred mesh particle size to four mesh particle size with multiple materials of different sizes used simultaneously. The polymer may include agents to such as a binder, hardener, initiator, or combination of such. The particulate material(s) and polymers, binders, resins, colorants, dyes, etc. are then mixed resulting in a slightly damp mixture. This initial mixture may be processed through a crushing machine to reduce the size of the combined particles. The resultant, finer mixture may be poured into a supporting mold, tray, or other supporting structure, after that, the slab is moved into a vacuumed press machine to be pressed, and then, moved into a curing machine to be cured into a hardened quartz slab. After curing, the slab is generally moved in a grinder to be grinded to a desired thickness, followed by a polisher to finish the product.

Quartz based stone has many advantages over natural stone such as marble and granite. Compared to these natural stones quartz is harder, stronger, less water absorbent, and more resistant to staining, scratching, breakage, chemicals, and heat. One of the drawbacks of quartz is its perceived lack of natural, random looking veins and color patterns compared with natural stones.

### SUMMARY OF THE INVENTION

One or more embodiments of the present invention address a method of producing a quartz based slab with single color patterns or multiple color patterns and/or veins.

One or more embodiments of the present invention provide a process in which additional colors or patterns are embedded into quartz composite material that may or may not already be colored or patterned, such as monochrome quartz or quartz that has gone through a process such as previously shown in U.S. Pat. No. 9,427,896, issued on Aug. 30, 2016 and in U.S. Pat. No. 9,707,698, issued on Jul. 18, 2017, which are incorporated by reference herein.

In at least one embodiment, an apparatus is provided comprising a computer processor; a first tool device; a first device configured to hold the first tool device; and a second device configured to move the first tool device in an x direction, a y direction, and a z direction, when the first tool device is being held by the first device, in response to commands from the computer processor; and a conveyor device having a belt. The first tool device may include a wheel. The first device may be configured with respect to the conveyor device, so that the wheel of the first tool device is configured to be lowered in the z direction into a material located on the belt of the conveyor device, and the first tool device is configured to be moved in the x and y direction, with the wheel simultaneously rotating and rolling through the material on the belt, in response to commands from the computer processor.

In at least one embodiment, the apparatus may further include a second tool device; wherein the first device is configured to hold either the second tool device or the first tool device but not both at the same time. The second tool device may includes a stirring blade. The first device may be configured with respect to the conveyor device, so that the stirring blade of the second tool device is configured to be lowered in the z direction into the material located on the belt of the conveyor device, and the second tool device is configured to be moved in the x and y direction, with the stirring blade of the second tool device, having its central axis simultaneously translated in the x and y direction, and rotating about its central axis, substantially parallel to the belt of the conveyor device in response to commands from the computer processor.

The apparatus may further include a table structure. The first device may move in the x and y direction on the table structure. The frame structure may have a plurality of members which form a closed perimeter. The material may be located within the closed perimeter on the belt of the conveyor device. The frame structure may be configured to be raised and lowered in response to commands from the computer processor.

The apparatus may further include a member. The first device may move in the y direction on the member, and the member may move in the x direction on the table structure.

In at least one embodiment of the present invention a method is provided comprising the steps of lowering a wheel of a first tool device into a material; creating a channel in the material by rotating and rolling the wheel of the first tool device through the material; and compressing the material after the channel has been created to fix the channel in the material. The material may be a particulate material.

The method may further include lowering a stirring blade of a second tool device into the material prior to compressing the material; rotating the stirring blade to mix the material, and wherein the step of compressing the material takes place both after the channel has been created and after the material has been mixed.

The first tool device may be removably connected to a first device; and the method may further comprise moving the first device in an x and y direction to move the first tool device in the x and y direction and to cause the wheel of the first tool device to move in an x and y direction, and to rotate and roll through the material.

The first tool device and the second tool device may be removably connected to a first device, such that only one of the first tool device and the second tool device are connected to the first device at a time.

The method may further include moving the first device in an x and y direction to move the first tool device in the x and y direction and to cause the wheel of the first tool device to move in an x and y direction, and to rotate and roll through the material, when the first tool device is connected to the first device; and moving the first device in an x and y direction to move the second tool device in the x and y direction and to cause the stirring blade of the second tool device to move in an x and y direction, and to rotate and thereby mix the material, when the second tool device is connected to the first device.

The first device may move in the x and y direction on a table structure. The material may be located within a closed perimeter of a frame structure on the belt of the conveyor device. The method may further include raising or lowering the frame structure in response to commands from the computer processor. The first device may be mounted on a member; wherein the member moves in the x direction on the table structure to move the first device in the x direction on the table structure; and wherein the first device moves in the y direction, while the member remains stationary, to move the first device in the y direction on the table structure.

### BRIEF DESCRIPTION OF THE DRAWINGS

FIG. 1 shows a left, top, and front view of an apparatus in accordance with an embodiment of the present invention, with the apparatus in a first state, with a press wheel device tool used;

FIG. 2 shows a close up view of some of the components of the apparatus of FIG. 1;

FIG. 3 shows a top view of the apparatus of FIG. 1 with the apparatus of FIG. 1 in a second state;

FIG. 4 shows a close up perspective view of some of the components of the apparatus of FIG. 1;

FIG. 5 shows a close up front view of some of the components of the apparatus of FIG. 1;

FIG. 6 shows a close up perspective view of the some of the components shown in FIG. 1 with a stirring tool;

FIG. 7 shows a top, left, and front perspective view of the apparatus of FIG. 1 in a third state, with a stirring tool used;

FIG. 8 shows a top, left and front perspective view of some of the components of the apparatus of FIG. 1 in a fourth state, with a stirring tool used;

FIG. 9 shows a perspective view of a spray device and a press wheel device tool for use with the apparatus of FIG. 1;

FIG. 10 shows a block diagram of components for use with the apparatus of FIG. 1, in at least one embodiment of the present invention;

FIG. 11 shows a top, left, and front perspective view of the majority of the spray device of FIG. 10, with a stirring tool used;

FIG. 12 shows components for another tool which can be attached to the spray device of FIG. 9;

FIG. 13 shows a simplified image of a finished slab of material, in accordance with an embodiment of the present invention with finished compressed channels; and

FIG. 14 shows a simplified image of another finished slab of material, in accordance with another embodiment of the present invention, with finished compressed and mixed channels.

### DETAILED DESCRIPTION OF THE DRAWINGS

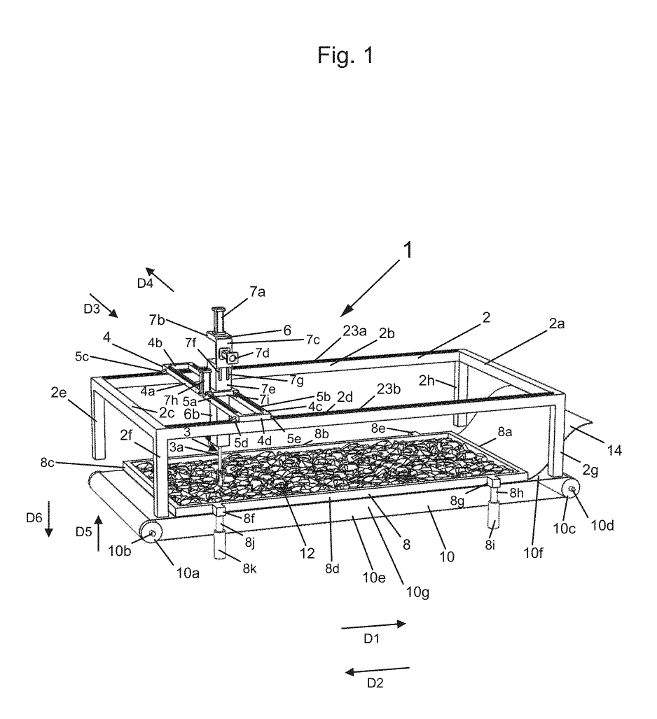

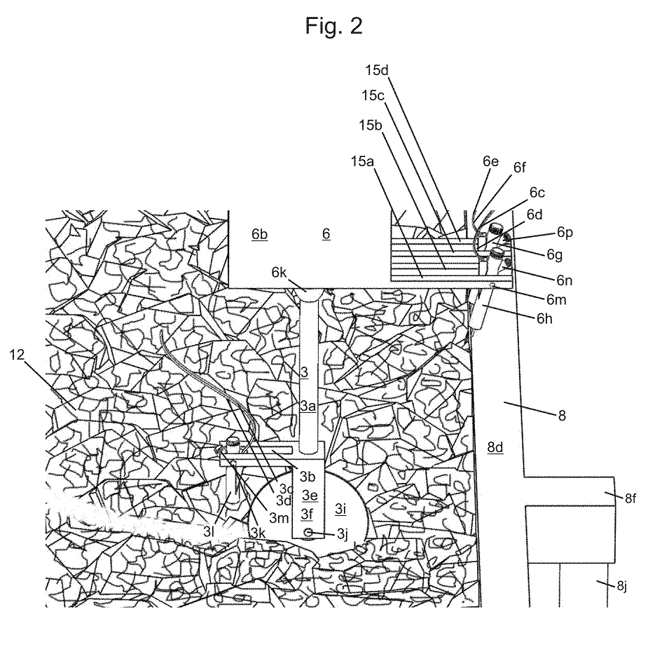

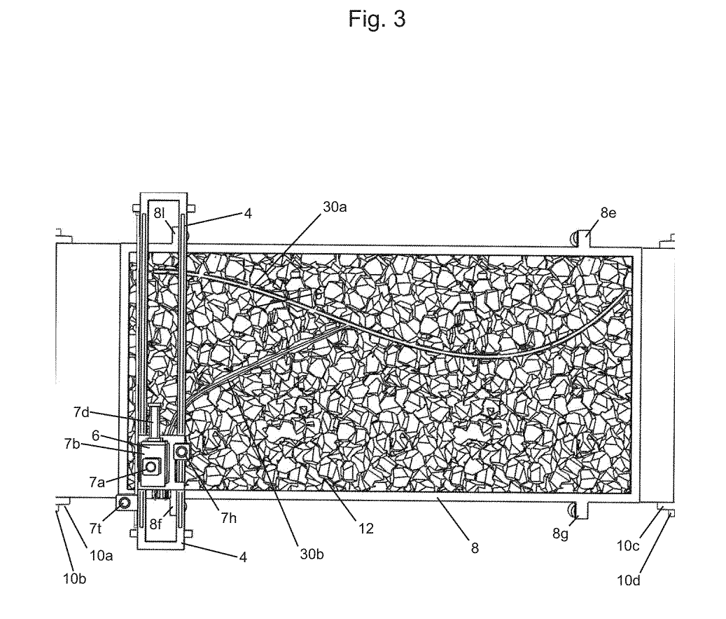

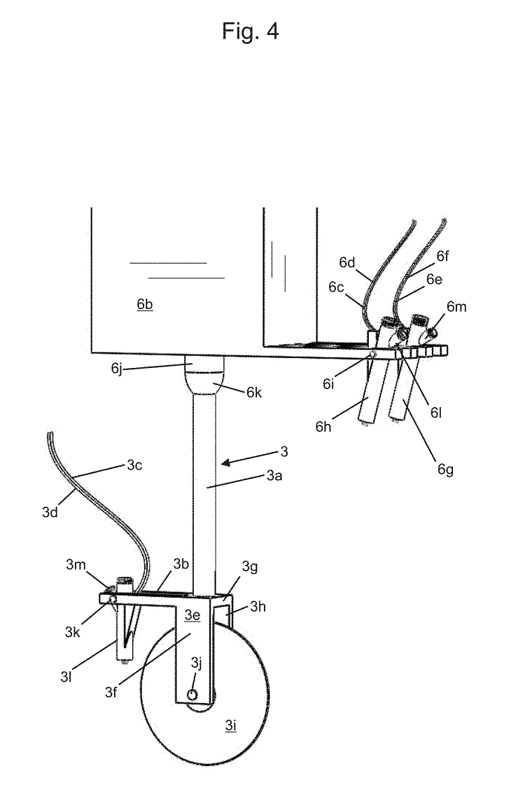

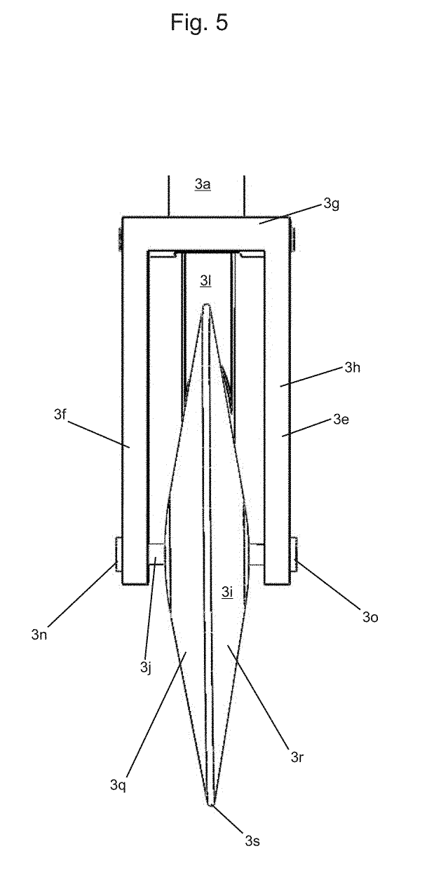

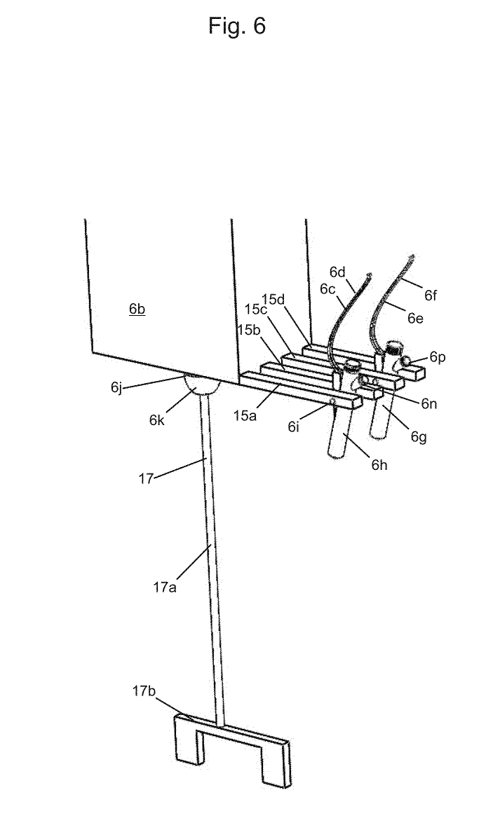

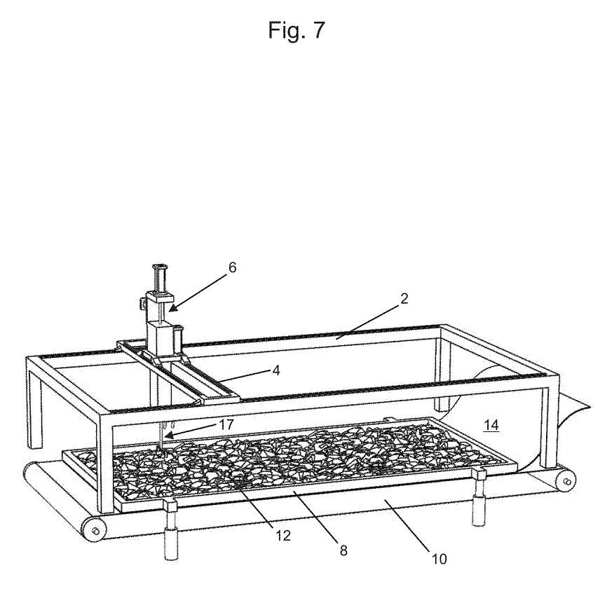

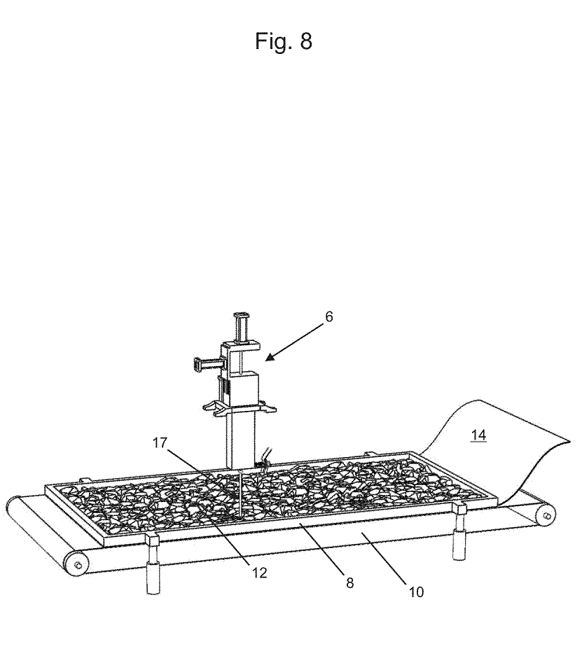

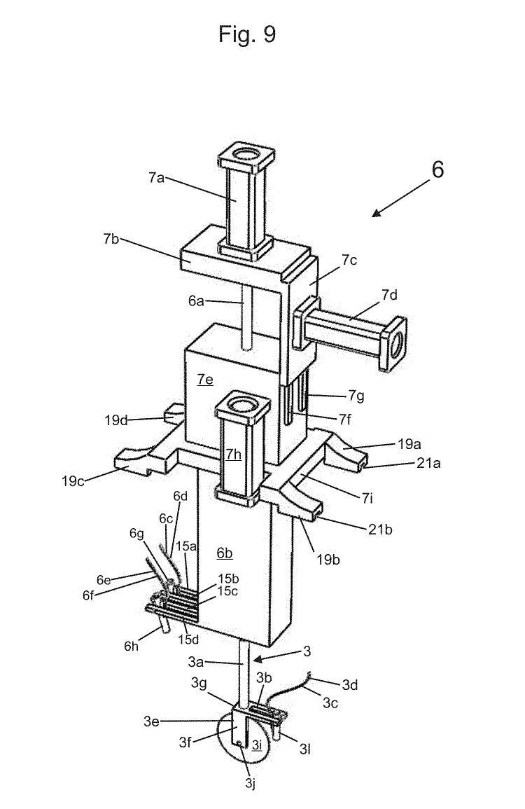

FIG. 1 shows a left, top, and front view of an apparatus 1 in accordance with an embodiment of the present invention, with the apparatus 1 in a first state, with a wheel device or tool 3 used. FIG. 2 shows a close up view of some of the components of the apparatus 1 of FIG. 1, with a wheel device or tool 3 used. FIG. 3 shows a top view of the apparatus 1 of FIG. 1 with the apparatus 1 of FIG. 1 in a second state. FIG. 4 shows a close up perspective view of some of the components of the apparatus 1, with a wheel device or tool 3 also shown. FIG. 5 shows a close up front view of some of the components of the wheel device tool 3. FIG. 6 shows a closeup perspective view of some of the components of the apparatus 1 of FIG. 1, along with an additional alternative component, which is stirring device or tool 17. FIG. 7 shows a top, left, and front perspective view of the apparatus 1 in a third state, with the stirring device or tool device 17 used. FIG. 8 shows a top, left and front perspective view of some of the components of the apparatus 1 in a fourth state, with the stirring device or tool 17 used. FIG. 9 shows a perspective view of the device 6 and the wheel device or tool 3.

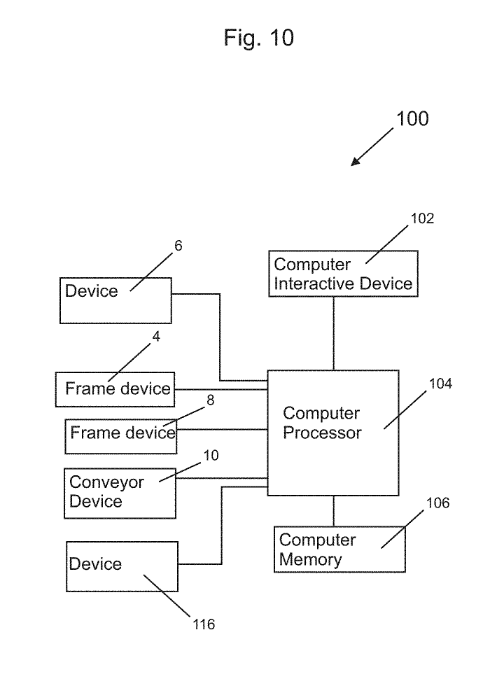

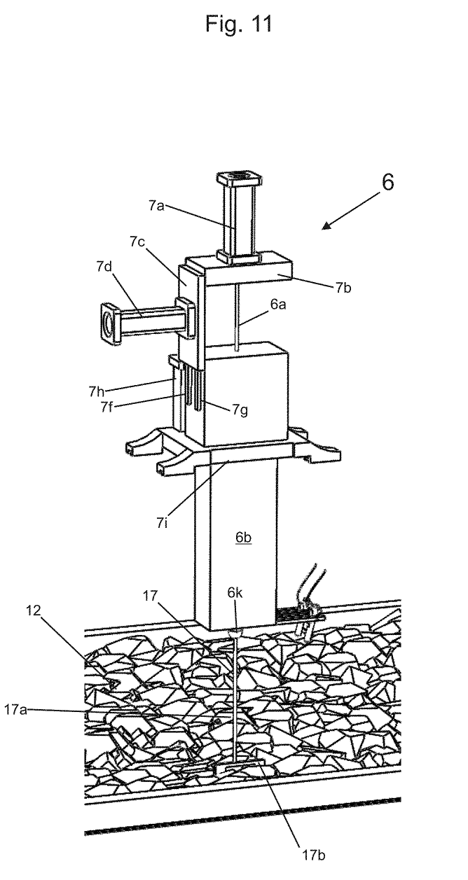

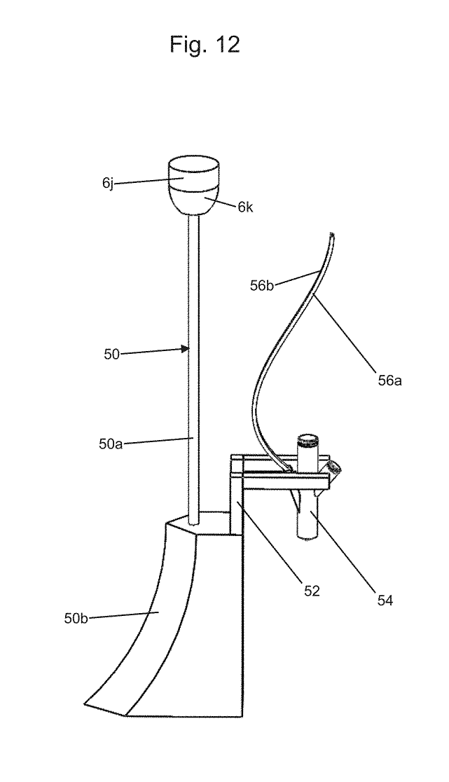

FIG. 10 shows a block diagram 100 of components for use with the apparatus 1 of FIG. 1, in at least one embodiment of the present invention. FIG. 11 shows a top, left, and front perspective view of the majority of the device 6 of FIG. 9, with a stirring device or tool 17 used. FIG. 12 shows components for a tool and/or device 50 which can be attached to the device 6 of FIG. 9.

Referring to FIG. 1, the apparatus 1 includes a table structure or member 2, a rectangular structure or member 4, a device 6, structure or member 8, a conveyor belt structure or device 10, material 12, and a sheet 14.

The table structure or member 2 includes members 2a, 2b, 2c, 2d, and legs or members 2e, 2f, 2g, and 2h. The table structure or member 2 sits or rests on a base or housing not shown, so that the structure member 2 is fixed at a location.

The rectangular structure or member 4 includes members 4a, 4b, 4c, and 4d, rails 5a and 5b, and protrusions 5c, 5d, 5e, and another protrusion opposite 5c, which is not shown. The rectangular structure 4 slides along members 2b and 2d of the table structure or member 2, in the directions D1 and D2, parallel to the members 2b and 2d, with protrusions 5d and 5e sliding on top of rail 23b on member 2d, and protrusion 5c, and the protrusion opposite 5c, not shown, sliding on top of rail 23a of member 2b. The protrusions 5d and 5e, are similar to protrusions or members 19a and 19b, having slots, similar or identical to slots 21a and 21b, into which rail 23b is inserted while the protrusions 5d and 5e ride on rail 23b. Similarly or identically the protrusion or member 5c and an identical opposite member, not shown have slots similar or identical to slots 21a and 21b, into which rail 23a is inserted while the protrusions 5c and the slot opposite, not shown, ride on rail 23a.

Referring to FIGS. 1, 2, 4, and 9, the device 6 includes members 7a, 7b, 7c, 7d, axle or shaft 6a, members 7e, 7f, 7g, 7h, 7i, members or extensions 15a, 15b, 15c, and 15d, and members 19a, 19b, 19c, 19d, slots 21a, 21b (shown in FIG. 9). In FIGS. 1, 2, 4, and 9, a wheel device and/or tool 3 may be attached to the device 6. The wheel device and/or tool 3 may include shaft or member 3a which is attached to member or socket 6k to the device 6. The wheel device or tool 3 further includes wheel 3i, U-shaped member 3e (including members 3f, 3g, and 3h, shown in FIG. 5), slot 3b, member or spray device 3l, pin or axle 3k, protrusion 3m, compressed air tubes 3c and dye tube 3d, and pin or axle 3j.

The device 6 may further include spray devices 6g and 6h, pin 6i, compressed air tubes 6c, 6e, and dye tube 6d, 6f, and protrusions 6l and 6n.

The device 6 slides along rails 5a and 5b in the directions D3 and D4 shown in FIG. 1, perpendicular to the members 2b and 2d of the table structure 2, with the rail 5a inserted into slot 21b and the rail 5b simultaneously inserted into slot 21a so that members 19c and 19b ride on rail 5a and members 19d and 19a ride on rail 5b. Other structure or methods for moving tool 3 or tool 17 or tool 50 in an x-y-z plane parallel to the plane of conveyor belt top portion 10f, within the perimeter of members 8a-d may be provided.

Referring to FIG. 1, the frame structure or member 8 includes members 8a, 8b, 8c, and 8d forming a rectangular structure and perimeter, retaining the material 12, on the sheet 14 on the top portion 10f of the conveyor device 10. The members 8a, 8b, 8c, 8d, and a portion of a top part 10f of the belt 10e, form an open box structure, wherein the material 12 is placed on the sheet 14, which is on the top part or portion 10f of the belt 10e, within the perimeter of members 8a, 8b, 8c, and 8d. The frame structure or member 8 further includes protrusions or extensions 8l, 8e, 8f, and 8g, shown in FIG. 3, members or posts 8j, 8h, shown in FIG. 1, and two further posts or members for extensions 8l and 8e, and members or bases 8i, and 8k shown in FIG. 1, and two further members or bases corresponding for extensions 8l and 8e. The structure or member 8 allows the frame or combination of members 8a-d to be moved upwards or downwards in the directions D5 or D6, respectively, parallel to member or leg 2f, of the table structure 2 to lower or raise the frame or combination of members 8a-8d. The structure or member 8 may be, or may include a hydraulic lift device, and a power source for controlling.

The members 8j and 8h, and other members on the side with protrusions 8e and 8l, shown in FIG. 3 may be hydraulic cylinders which are part of a hydraulic device for moving the frame 8 up and down.

The conveyor belt structure or device 10 includes pin or axles 10b and 10d, rollers 10a and 10c, and belt 10e, which as shown in FIG. 1 has a top part 10f, and a bottom part 10g.

FIG. 1 shows an initial stage or state of production after the material 12, which may be quartz composite material, has been evenly placed onto a sheet 14, which is on a portion of the top part 10f of the belt 10e, wherein that portion of the belt 10e is surrounded by the frame or combination of members 8a, 8b, 8c, and 8d. The device 6 may be mounted and/or move on the frame of members 4a, 4b, 4c, and 4d, and then the frame of members 4a, 4b, 4c, and 4d may move along the table structure 2 to provide movement of the device 6 in the x, y planes by servo motors, which may be located inside of and/or be a part of member or housing 7e shown in FIG. 1, and/or located in the table structure 2 and/or the member or frame device 4.

The device 3l, 6h, 6g, 54 may be a dye delivery device, such as a standard industrial spray device. The area covered by the spray device and the amount of dye deposited on the material 12 may both be controlled by computer or computer processor 104, shown in FIG. 11.

FIG. 9 shows the device 6 along with a wheel device or tool 3 attached through socket or member 6k, shown in FIG. 4. The bracket 3e of the wheel device 3 may be rotated by shaft 3a driven by the servo motor 7a of device 6 to cause the wheel 3i to be at a different orientation with respect to member 8d of structure 8, as shown in FIG. 2, in order to always position the spray device 3l behind the press wheel 3i of its travel direction. For example, the wheel 3i in FIG. 2 is shown perpendicular to the member 8d, but it would be rotated by servo motor 7a to be parallel to member 8d or at some other angle with respect to member 8d. The wheel 3i may also be rotated about pin or axis 3j, shown in FIG. 2, the orientation direction of the press wheel 3i may be controlled by computer processor 104 shown in FIG. 11. The wheel 3i may be raised, out of the material 12, or lowered, into the material 12, by servo motor 7d, controlled by computer processor 104. The purpose of the wheel 3i is to cut a channel, such as a channel 30a or 30b, shown in FIG. 3, through the quartz material or material 12. A device including component 3l, shown in FIG. 4, positioned behind the wheel 3i is responsible for spraying colored dye onto the side walls of the channel, such as 30a and 30b, formed by the wheel 3i. There may be multiple spray devices, similar or identical to device 3l, so that multiple dyes may be applied.

Alternatively, a shovel-like device such as 50b shown in FIG. 12 may be used to form a rectangular or v-shaped channel. This would achieve a similar result to the v-shaped wheel 3i mentioned above.

FIG. 2 shows the wheel 3i embedded in the quartz composite material 12 with the spray component 3l behind the wheel 3i, i.e. the wheel 3i travels forward so that it cuts through the material 12 first and then the spray component 3l trails behind.

FIG. 3 shows an example of paths 30a and 30b carved by the wheel 3i in the material 12. In order to form branched patterns or paths, such as 30a and 30b in the material 12, the wheel 3i is raised out of the material 12, repositioned or rotated (change orientation of wheel 3i with respect to the material 12, and with respect to member 8b, and then lowered to another area of the material 12. FIG. 2 shows the wheel 3i substantially perpendicular to the member 8d, however, the wheel 3i can be rotated or changed in orientation with respect to the member 8d, so that the wheel 3i is parallel to member 8d, or at some other angle with respect to the member 8d, by turning shaft 3a which changes the orientation of wheel 3i with respect to the member 8d, in other words, the spray device 3l is always rotatable (driven by servo motor 7a) positioned behind the press wheel 3i on the traveling direction of the press wheel 3i, and only spray into the channel after the channel is formed by the press wheel 3i.

Once the entire pattern within perimeter of members 8a, 8b, 8c, and 8d is created, the quartz composite material 12 is transferred to a press machine by pulling the sheet 14 and rotate the belt 10e. When the press machine is lowered onto the quartz composite material 12, the channels or paths previously created by the wheel 3i, such as 30a and 30b, shown in FIG. 3, close. The dyed side walls will tend to be pushed together, creating lines of dye that simulate natural stone on the surface of the slab after the slab of the material 12 has been cured, grinded, and polished.

FIG. 6 shows a stirring device and/or tool 17 instead of the press wheel device and/or tool 3 used in a separate method of color or pattern formation. Also shown are two separate angled spraying devices or members 6g and 6h. There may be one or multiple of these devices used depending on the final design aesthetic desired. In at least one embodiment, the component 17b or stirring blade is lowered into the quartz composite material 12 so that when it rotates the quartz composite material 12 is disrupted and reoriented. While this stirring blade 17b is reorienting and flipping the material 12 one or more spray devices, such as 6g and/or 6h will be depositing dye onto the surface of the exposed composite quartz material 12. The amount of dye deposited and the spray pattern, in a least one embodiment, are controlled by computer processor 104 shown in FIG. 10. In general, the further away from the axis of rotation of axle 17a, and 17b, of the stirring device 17, the less dye will be deposited. The purpose of this process is to apply dye onto more surface area of the random sized quartz composite material pieces while the area is being flipped.

Once this process is finished, the modified quartz composite material 12 is transferred to a press machine. When this press machine is lowered onto the modified quartz composite material, the quartz composite material is compressed to form a further modified material. The dyed pattern is embedded throughout the slab of further modified material. Once the slab of further modified material has been pressed, cured, grinded and polished the final design aesthetic will be revealed on the surface of the finished slab.

The size of the quartz composite material pieces may be controlled by adjusting the formula. In general, the more resin and the higher percentage of fine quartz powder used in the formula will result in larger pieces of quartz composite material.

The different processing utilizing the wheel device or tool 3 or shovel device or tool 50 shown in FIG. 12 and the stirring device or tool 17, may be used independently or subsequently in order to achieve a desired design aesthetic. Each of the wheel 3i, the stirring blade 17b, and the shovel implement 50b may be considered to be a tool, implement, working tool, or working implement for physically manipulating the material 12.

The gantry or member or frame 4 supporting the delivery device 6 may be replaced by a standard industrial robotic arm.

FIG. 10 shows a block diagram 100 of components for use with the apparatus 1 of FIG. 1, in at least one embodiment of the present invention. All of the components of FIG. 10 may be part of the apparatus 1 of FIG. 1. The block diagram 100 includes computer interactive device 102, which may be any type of computer interactive device, such as a touch screen, computer keypad, or a computer mouse. The block diagram 100 further includes computer processor 104, computer memory 106, and devices 4, 6, 8, and 10 (previously referred to in reference to FIG. 1. In at least one embodiment, the computer processor may control the device 3i, 6h,6g, 54, such as a known industrial spray device to spray the material 12 in accordance with one or more embodiments of the present invention. The computer processor 104 may control movement of the device 6, through servo motor 7h, such as located inside of member or housing 7e (shown in FIG. 11), in the directions D3 or D4 along the rails 5a and 5b of the frame device 4 shown in FIG. 1. The computer processor 104 may control movement of the frame device 4 through servo motor 7t, for example in members 4b and 4d, to cause the frame device 4, to move in the directions D1 or D2, on the rails 23a and 23b, as shown in FIG. 1.

The computer memory 106 may have stored therein information, such as coordinates, direction, or other information or data regarding a predetermined path which the tool device 3 (including wheel 3i) should traverse or which the stirring tool device 17 should traverse. The computer memory 106 may also have stored therein an amount of color, such as amount of color dye being delivered to an area that is being stirred. The computer processor 104 may be programmed by computer software in computer memory 106 to access this data or information and thereby control the device 6, the wheel tool device 3, and/or the stirring tool device 17, spray timing and spray amount of the color.

The computer processor 104 may also control the servo motor 7a shown in FIG. 9, to thereby control rotation of either axle 3a of the wheel device tool 3, or axle 17a of the stirring device or tool 17 (in FIG. 6), or axle 50a of the shovel device 50 (in FIG. 12).

The computer processor 104, through communication with device 6, may also control sprayers, such as sprayers or members 6g and 6h, sprayer 54 shown in FIG. 12, or sprayer or member 3l shown in FIG. 4 through electromagnetic switches, not shown. Tube 3c may be used for compressed air go into the spray device 3l, and tube 3d may be used for liquid dye feed into the spray device 3l, wherein the spray device 3l is an industry standard device. Similarly, tube 6c may be used for compressed air go into the spray device 6h, and tube 6d may be used for liquid dye feed into the spray device 6h, wherein the spray device 6h is an industry standard device. Similarly, tube 6f may be used for compressed air go into the spray device 6g, and tube 6e may be used for liquid dye feed into the spray device 6g, wherein the spray device 6g is an industry standard device.

In at least one embodiment, the compressed air is turned on and off by a standard electromagnetic switch (not shown in the drawing, which could be on and off fifty times per second if needed) which is controlled by computer processor 104, and which turned on causes more dye to come out of spray devices, such as 6g and 6h, and when turned off will stop the dye from coming out of spray devices 6g and 6h.

The computer processor 104 through communication with frame device 8, may raise and lower the frame of the combination of members 8a-d, by causing members 8j and 8h (such as a hydraulic cylinder) for raising member 8d side of 8 and corresponding members for raising member 8b side of 8, in the directions of D5 and D6 as shown in FIG. 1.

The computer processor 104 through communication with conveyor belt device 10 may cause the axles 10a and 10d to rotate (driven by a servo motor, not shown here) causing the rollers 10a and 10c to spin about their axles and corresponding axes, and thereby causing the belt 10e to rotate, so that each portion of the belt 10e traverses a cycle where each portion of the belt 10e moves in the direction D1, then rolls over and under the roller 10c, then moves in the direction D2, then rolls under and over the roller 10a, and then repeats the cycle. The speed of the belt 10e rotation can be adjusted by the computer processor 104 by adjusting the rotational speed of the axles 10b or 10d, and the rollers 10a, and 10c.

FIG. 11 shows a top, left, and front perspective view of the spray device 6 of FIG. 9, with the stirring tool 17, with component 17b inserted into the material 12, for flipping the material 12 while spraying dye onto the flipping area, creating patterns in the material 12.

FIG. 12 shows components for a tool 50 which can be attached to the device 6. The tool 50 may include bar, rod, or shaft 50a, and tool 50b. The tool 50 may include bracket 52, spray device 54, and tubes 56a and 56b, for providing compressed air and liquid dye feed, respectively, for connecting the spray device 54. The spray device 54 may be controlled by computer processor 104.

In at least one embodiment of the present invention a method is provided which includes the following steps. First, the sheet paper 14 is laid on the conveyor belt top surface or portion 10f. Next the frame 8 is lowered onto the conveyor belt top surface or portion 10f. Then, the material 12 is distributed onto the sheet paper 14 within the frame or within the perimeter defined by members 8a, 8b, 8c, and 8d. Next the function of stirring the material 12 is done, typically, by using the tool 17, shown in FIG. 6, with stirring blade or head 17b, while spraying dye onto the stirring area. The stirring blade tool head 17b is lowered into the material 12, and the stirring blade 17b is rotated or driven by servo motor 7a of device 6, the start or stop time and rotation speed is controlled the by computer, to rotate shaft 17a, thereby rotating blade 17b about longitudinal axis of 17a, to flip the material 12 and at the same time spray the color onto the area of the material 12 being flipped, by used of devices 6g and 6h shown in FIG. 6, subject to computer processor 104 control, and then the device 6 continues to travel in a plane parallel to surface of sheet 14 (within the perimeter of members 8a-d) through all of a pre-designed path through the material 12.

Next, change the stirring tool 17 to press wheel tool 3, the function of the press wheel device 3, shown in FIG. 2, is performed by lowering the press wheel 3i down into the material 12, reorient (drive by servo motor 7a also), to rotate the shaft 3a, to orient the press wheel 3i. The press wheel 3i will go in a direction, so that the spray head 3i mounted behind the press wheel 3i always will be behind the press wheel 3i as the device 6 travels in a plane parallel to the plane of the conveyor belt or surface of 14 within members 8a-d.

Generally, the stirring blade tool 17 can be replaced with the press wheel tool 3 from the socket or portion 6k of the device 6, or changed back. Depending on the design desired to be implemented in the material 12, we might perform the function with the stirring blade tool 17 only to finish producing the quartz slab, or we might perform function of the press wheel tool 3 only, or one after another by changing the tool used in socket 6k of device 6.

The device 6 is raised so that the stirring blade 17b or press wheel 3i will lift up and separated from material 12, the frame 8 may be raised, the paper sheet 14 may be pulled out to move the modified material of material 12 into next processing step.

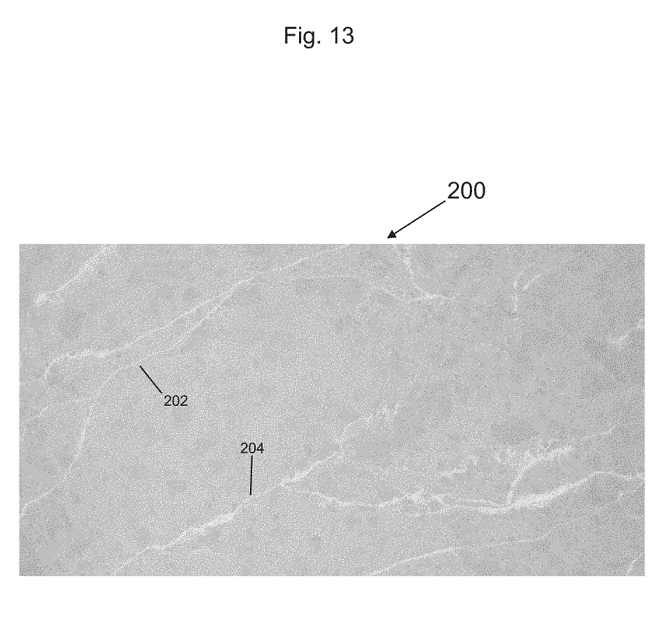

FIG. 13 shows a simplified image of a finished slab of material 200, in accordance with an embodiment of the present invention with finished compressed channels 202 and 204. The channels 202 and 204 were formed by the wheel 3i of the tool device 3.

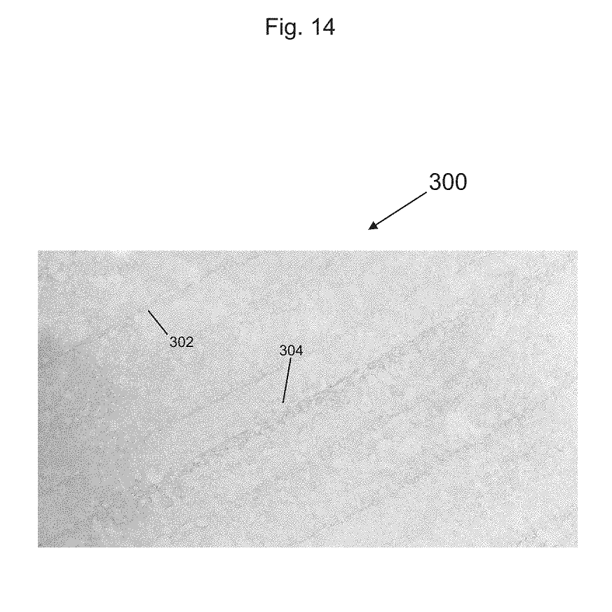

FIG. 14 shows a simplified image of another finished slab of material 300, in accordance with another embodiment of the present invention, with finished compressed and mixed channels 302 and 304. The finished compressed and mixed channels 302 were formed a combination of the tool device 3 (with wheel 3i) and the tool device 17 (with stirring blade 17b). An initial channel may have been formed by the tool device 3 (with wheel 3i) and then the tool device 17 (with stirring blade 17b) may be controlled by computer processor 104 to travel in the initial channels formed by wheel 3i, and to mix those initial channels to form a different pattern. Alternatively, the mixing may be done first by tool device 17 and then channels formed by wheel 3i, or a number of passes by each of tool device 17 and tool device 3 may be done, with a number of alterations between the two.

In one or more alternative embodiments, the gantry combination structure for controlling the x, y, z location of wheel 3i of wheel tool device 3, or the x, y, z, location of stirring blade 17b of the stirring tool device 17, spray timing and spray amount of the color, which may include member or structure 4, and table structure 2, may be replaced, or augmented for example, by a robotic arm or robotic device, such as robotic arm (6) shown in FIG. 1 of U.S. Pat. No. 9,671,274, inventor Alex Xie, issued Jun. 6, 2017, which is incorporated herein by reference. (U.S. Pat. No. 9,671,274, col. 4, Ins. 10-17). The robotic arm (6) and base (14) of U.S. Pat. No. 9,671,274 may be considered to include a first device for holding a tool device, such as for holding roller (10) or prongs (8a)-(8d), and a second device for moving the first device to a different x, y, z, location such as generally including the robotic arm (6) and the base (14). (U.S. Pat. No. 9,671,274, col. 4, Ins. 10-17)

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

1. An apparatus comprising:
a computer processor;
a first tool device;
a first device configured to hold the first tool device;
a second device configured to move the first tool device in an x direction, a y direction, and a z direction, when the first tool device is being held by the first device, in response to commands from the computer processor; and
a conveyor device having a belt;
wherein the first tool device includes a stirring blade; and
wherein the first device is configured with respect to the conveyor device, so that the stirring blade of the first tool device is configured to be lowered in the z direction into a material located on the belt of the conveyor device, and the first tool device is configured to be moved in the x and y direction, with the stirring blade simultaneously physically manipulating the material on the belt, in response to commands from the computer processor;
wherein the first tool device includes an elongated axle, having a first end fixed to the first device, and a second end fixed to the stirring blade;
wherein the elongated axle has a length and a width, with the length of the elongated axle substantially greater than the width of the elongated axle;
wherein the stirring blade has a width which is substantially greater than the width of the elongated axle; and
wherein the stirring blade of the first tool device is configured to be lowered in the z direction into the material, to physically manipulate the material, and thereafter to be raised out of the material in response to commands from the computer processor, while at least a majority of the material remains stationary at the same location.

2. The apparatus of claim 1 wherein the stirring blade includes first and second protrusions separated by a gap.

3. (canceled)

4. (canceled)

5. The apparatus of claim 1 further comprising
a second tool device;
wherein the first device is configured to hold either the second tool device or the first tool device but not both at the same time;
wherein the second tool device includes a v-shaped press wheel and the v-shaped press wheel physically manipulates the material on the belt, by rotating and rolling through the material on the belt to create a channel in the material.

6. The apparatus of claim 1 further comprising
a table structure; and
wherein the first device moves in the x and y direction on the table structure.

7. An apparatus comprising:
a computer processor;
a first tool device;
a first device configured to hold the first tool device;
a second device configured to move the first tool device in an x direction, a y direction, and a z direction, when the first tool device is being held by the first device, in response to commands from the computer processor; and
a device for moving a material into and out of a region;
wherein the first tool device includes a working implement; and
wherein the first device is configured with respect to the device for moving the material into and out of the region, so that the working implement of the first tool device is configured to be lowered in the z direction into a material located on a surface of the device for moving the material into and out of a region, and the first tool device is configured to be moved in the x and y direction, with the working implement simultaneously physically manipulating the material on the surface, in response to commands from the computer processor;
wherein the working implement of the first tool device is a v-shaped press wheel, and the v-shaped press wheel physically manipulates the material, by rotating and rolling through the material to create a channel in the material;
wherein the first tool device includes a spray device which is controlled by the computer processor, and which is configured to spray the material with a dye while the v-shaped press wheel is rotating and rolling through the material; and
wherein the spray device is fixed in the first tool device and the v-shaped press wheel is rotatably mounted in the first tool device, so that when the first tool device is moved in the x and y direction, the spray device and the v-shaped press wheel are simultaneously moved in the x and y direction; and
wherein the spray device is fixed with respect to the v-shaped press wheel and the first tool device is oriented with respect to the device for moving the material into and out of the region, and the first tool device is configured to be moved in the x and y direction to cause the v-shaped press wheel to carve a path in the material, so that the spray device is behind the v-shaped press wheel.

8. The apparatus of claim 7 wherein
the spray device is fixed with respect to the v-shaped press wheel, so that if the v-shaped press wheel is in contact with the material, the spray device is less than a distance equal to the diameter of the v-shaped press wheel from the material.

9. The apparatus of claim 6 further comprising
a member; and
wherein the first device moves in the y direction on the member, and the member moves in the x direction on the table structure.

10. The apparatus of claim 1 wherein
the first tool device includes a spray device which is controlled by the computer processor, and which is configured to spray the material with a dye while the stirring blade of the first tool device physically manipulates the material.

11. The apparatus of claim 5 wherein
the first device includes a spray device which is controlled by the computer processor, and which is configured to spray the material with a dye while the stirring blade of the first tool device is stirring the material; and
the second tool device includes a spray device which is controlled by the computer processor, and which is configured to spray side walls of the channel of the material with a dye after the v-shaped press wheel has created a channel in the material.

12. A method comprising the steps of:
lowering a stirring blade of a first tool device into a material;
rotating the stirring blade of the first tool device through the material, to thereby physically manipulate the material;
wherein the material is a particulate material; and
wherein the first tool device consists of a single elongated axle and a stirring blade;
wherein the single elongated axle has a first end fixed to a first device, and a second end fixed to the stirring blade;
wherein the single elongated axle has a length and a width, with the length of the single elongated axle substantially greater than the width of the elongated axle;
wherein the stirring blade has a width which is substantially greater than the width of the single elongated axle; and
wherein the stirring blade of the first tool device is configured to be lowered in the z direction into the material, to physically manipulate the material, and thereafter to be raised out of the material in response to commands from the computer processor, while a majority of the material remains stationary at the same location.

13. The method of claim 12 wherein
the stirring blade includes first and second protrusions separated by a gap.

14. (canceled)

15. (canceled)

16. The method of claim 12 further comprising
lowering a v-shaped press wheel of a second tool device into the material; and
moving the v-shaped press wheel through the material to manipulate the material.

17. The method of 12 wherein
the first tool device is removably connected to the first device;
and the method further comprises moving the first device in an x and y direction to move the first tool device in the x and y direction and to cause the stirring blade of the first tool device to move in an x and y direction, and to thereby physically manipulate the material.

18. The method of claim 16 wherein
the first tool device and the second tool device are removably connected to a first device, such that only one of the first tool device and the second tool device are connected to the first device at a time;
and the method further comprises moving the first device in an x and y direction to move the first tool device in the x and y direction and to cause the v-shaped press wheel of the second tool device to move in an x and y direction, and to rotate and roll through the material, when the second tool device is connected to the first device;
and moving the first device in an x and y direction to move the first tool device in the x and y direction and to cause the stirring blade of the first tool device to move in an x and y direction, and to rotate and thereby flip the material, when the first tool device is connected to the first device.

19. The method of claim 18 wherein
the first device moves in the x and y direction on a table structure.

20. A method comprising the steps of:
lowering a working implement of a first tool device into a material;
moving the working implement of the first tool device through the material, to thereby physically manipulate the material;
wherein the material is a particulate material;
wherein the working implement of the first tool device is a v-shaped press wheel, and the wheel physically manipulates the material, by rotating and rolling through the material to create a channel; and
wherein the first tool device includes a spray device which is controlled by the computer processor, and which is configured to spray the material with a dye onto a side wall of the channel; and
wherein the spray device is fixed in the first tool device and the v-shaped press wheel is rotatably mounted in the first tool device, so that when the first tool device is moved in an x and y direction, the spray device and the v-shaped press wheel are simultaneously moved in the x and y direction; and
wherein the spray device is fixed with respect to the v-shaped press wheel and the first tool device is oriented with respect to a device for moving the material into and out of the region, and the first tool device is configured to be moved in the x and y direction to cause the v-shaped press wheel to carve a path in the material, so that the spray device is behind the v-shaped press wheel.

21. The method of claim 20 wherein
the spray device is fixed with respect to the v-shaped press wheel, so that if the v-shaped press wheel is in contact with the material, the spray device is less than a distance equal to the diameter of the v-shaped press wheel from the material.

22. The method of claim 18 wherein
the first device is mounted on a member;
wherein the member moves in the x direction on the table structure to move the first device in the x direction on the table structure; and
wherein the first device moves in the y direction, while the member remains stationary, to move the first device in the y direction on the table structure.

23. The method of claim 12 further comprising
spraying the material with a dye after the working implement of the first device has physically manipulated the material.

24. The method of claim 16 wherein
the first device includes a spray device which is controlled by a computer processor, and which is configured to spray the material with a dye while the stirring blade of the first tool device is stirring the material.

25. An apparatus comprising:
a computer processor;
a first tool device;
a second tool device;
a first device configured to hold either the first tool device or the second tool device;
a second device configured to move the first tool device in an x direction, a y direction, and a z direction, when the first tool device is being held by the first device, in response to commands from the computer processor; and
a conveying device for moving a material into and out of a region;
wherein the first tool device includes a v-shaped press wheel;
wherein the first tool device includes a spray device which is controlled by the computer processor, and which is configured to spray the material with a dye;
wherein the spray device is fixed to the first tool device and the v-shaped press wheel is mounted to the first tool device so that when the first tool device is moved in the x and y direction with respect to the material, the spray device and the v-shaped press wheel both move in the x and y direction respect to the material;
wherein the v-shaped press wheel of the first tool device is configured to be lowered in the z direction into the material located on a surface of the conveying device for moving the material into and out of the region, and the first tool device is configured to be moved in the x and y direction, with the v-shaped press wheel simultaneously physically manipulating the material, in response to commands from the computer processor;
wherein the material is located within the closed perimeter on the surface; and
wherein the v-shaped press wheel of the first tool device is configured to be lowered in the z direction into the material, to physically manipulate the material, and thereafter to be raised out of the material.

26. An apparatus comprising:
a computer processor;
a first tool device;
a first device configured to hold the first tool device;
a second device configured to move the first tool device in an x direction, a y direction, and a z direction, when the first tool device is being held by the first device, in response to commands from the computer processor; and
a conveying device for moving a material into and out of a region;
wherein the first tool device includes a working implement; and
wherein the first device is configured with respect to the conveying device for moving the material into and out of the region, so that the working implement of the first tool device is configured to be lowered in the z direction into a material located on a surface of the device for moving the material into and out of a region, and the first tool device is configured to be moved in the x and y direction, with the working implement simultaneously physically manipulating the material on the surface, in response to commands from the computer processor;
wherein the working implement of the first tool device is a v-shaped press wheel, and the v-shaped press wheel physically manipulates the material, by rotating and rolling through the material to create a channel; and
wherein the v-shaped press wheel forms a v-shaped channel when the v-shaped press wheel rolls through the material, such that the v-shaped channel is configured to close when a press machine is lowered onto the material.

27. The apparatus of claim 25 wherein
the v-shaped press wheel has a diameter and a bottom; and
wherein the spray device is fixed with respect to the v-shaped press wheel, so that an end of the spray device is less than the diameter of the v-shaped press wheel above the bottom of the v-shaped press wheel.

28. The apparatus of claim 7 wherein
the v-shaped press wheel has a diameter and a bottom; and
wherein the spray device is fixed with respect to the v-shaped press wheel, so that an end of the spray device is less than the diameter of the v-shaped press wheel above the bottom of the v-shaped press wheel.

29. A processed hardened slab formed by the process of:
placing a particulate material on a sheet, while the particulate material is in a state so that the particulate material can be mixed and compressed; and
forming a channel in the particulate material by use of a rotating v-shaped press wheel, while the particulate material is on the sheet;
spraying dye into the channel;
closing the channel after the dye has been sprayed into the channel; and
hardening the particulate material after the channel has been closed.
